(19) United States
(12) Patent Application Publication
(10) Pub. No.: US 2008/0122867 A1
(43) Pub. Date: May 29, 2008

(54) METHOD FOR DISPLAYING EXPRESSIONAL IMAGE

(75) Inventor: Shao-Tsu Kung, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COMPAL ELECTRONICS, INC., Taipei City (TW)

(21) Appl. No.: 11/671,473

(22) Filed: Feb. 6, 2007

(30) Foreign Application Priority Data
Sep. 27, 2006 (TW) 95135732

(51) Int. Cl. G09G 5/00

(52) U.S. Cl. 345/629

(57) ABSTRACT

A method for displaying an expressional image is provided. In the method, each of the facial images input by a user is set with an expressional type. After that, a suitable action episode is selected according to the movement of the user. A facial image of the user corresponding to the action episode is inserted in the action episode for expressing the emotion of the user, such that the recreation effect is enhanced. In addition, the expressional type of the displayed facial image can be switched, so as to make the displayed facial image match the action episode. Therefore, the flexibility and convenience for the use of the present invention can be improved.

### CROSS-REFERENCE TO RELATED APPLICATION

This application claims the priority benefit of Taiwan application serial no. 95135732, filed on Sep. 27, 2006. All disclosure of the Taiwan application is incorporated herein by reference.

### BACKGROUND OF THE INVENTION

1. Field of the Invention

The present invention relates to a method for displaying an image. More particularly, the present invention relates to a method for displaying an expressional image.

2. Description of Related Art

With the progress of information science and technology, computers have become an indispensable tool in modern people's life no matter in terms of editing document, receiving and sending e-mails, transmitting text messages, and performing video conversation. However, as people rely much on computers, the average time that each person spends in using computers is increasing annually. In order to relax both the body and mind of computer users after working on computers, technicians in the field of software devote themselves to developing application software providing recreation effect, so as to reduce the working pressure of computer users and increase the fun of using computers.

Electronic pets are one of the examples. The action of an electronic pet (e.g., an electronic chicken, an electronic dog, or an electronic dinosaur) is changed by detecting the trace of the cursor moved by the user or the actions performed by the user on the computer screen, thereby representing the emotion of the user. The user can further create an interaction with the electronic pet by using additional functions such as feeding, accompanying, or playing periodically, so as to achieve the recreation effect.

Recently, a similar application integrated with an image capturing unit has been developed, which can analyze a captured image and change the corresponding graphic displayed on the screen. Taiwan Patent No. 458451 has disclosed an image driven computer screen desktop device, which captures video images with an image signal capturing unit, performs an action analysis with an image processing and analysis unit, and adjusts the displayed graphic according to the result of action analysis. FIG. 1 is a block diagram of a conventional image driven computer screen desktop system. Referring to FIG. 1, this device includes a computer host 110, an image signal capturing unit 120, an image data preprocessing unit 130, a form and feature analysis unit 140, an action analysis unit 150, and a graphic and animation display unit 160.

The processes of operation include the following steps. First, images are captured by the image signal capturing unit 120, and the images and actions of the user are converted into image signals by a video card and then input to the computer host 110. Preprocesses such as position detection, background interference reduction, and image quality improvement are performed on the above images by the image data preprocessing unit 130 with image processing software. The form and feature analysis unit 140 performs analysis on the moving status of feature position or the variation of feature shape, and then correctly positions and extracts the action portions to be analyzed by means of graphic recognition, feature segmentation, or the like. The action analysis unit 150 performs a deformation and shift meaning decoding analysis according to whether the face of the user is smiling or not or according to the moving frequency of other parts of the body. Finally, the graphic and animation display unit 160 drives the computer screen to display the graphic variation with a predetermined logic set by software according to the above action.

It can be known from the above description that the conventional art changes graphic pictures displayed on the screen only by imitating the action of the user. However, the pure action variation can only make the original dull picture become more vivid, and the facial expressions of the user cannot be represented accurately, and thus the effect is limited.

### SUMMARY OF THE INVENTION

Accordingly, the present invention is directed to a method for displaying an expressional image, which includes setting an input facial image with a corresponding expressional type, so as to generate a graphic that contains expressions and matches an action episode after the action episode is selected, thereby enhancing the recreation effect.

As embodied and broadly described herein, the present invention provides a method for displaying an expressional image. First, a facial image is input, and then set with an expressional typ. An action episode is selected, and the action episode and the corresponding facial image according to the expressional type required by the action episode is displayed.

In the method for displaying an expressional image according to the preferred embodiment of the present invention, after setting the facial image with the expressional type, a plurality of facial images are further input, and each of the facial images is set with an expressional type. The facial image is stored each time after the facial image is input.

In the method for displaying an expressional image according to the preferred embodiment of the present invention, in the step of displaying the action episode and the corresponding facial image according to the expressional type required by the action episode, the corresponding facial image is selected according to the expressional type required by the action episode, the facial image in a position where the face is placed in the action episode is inserted, and finally the action episode containing the facial image is displayed. When displaying the facial image, the facial image is further rotated and scaled so as to make the facial image match the direction and size of the face in the action episode. Moreover, the present invention can further plan a plurality of actions in the action episode, dynamically play the actions, and adjust the direction and size of the facial image while playing the actions according to the currently played action.

In the method for displaying an expressional image according to the preferred embodiment of the present invention, the facial image is displayed according to the expressional type required by the action episode, and the facial images of different expressional types are switched and displayed, so as to make the displayed facial image match the action episode.

In the method for displaying an expressional image according to the preferred embodiment of the present invention, the action episode includes one of action poses, dresses, bodies, limbs, hairs, and facial features of a character or a combination thereof, and the expressional type includes one of peace, pain, excitement, anger, or fatigue. However, the present invention is not limited herein.

The present invention sets each of the facial images input by the user with a corresponding expressional type, selects a suitable action episode according to the motion of the user, and inserts the facial image of the user in the action episode for representing the expression of the user, thereby enhancing the recreation effect. In addition, the expressional type can be switched so as to make the displayed facial image match the action episode, thereby providing the flexibility and the convenience in use.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional image driven computer screen desktop system.

FIG. 2 is a block diagram of an expressional image display device according to a preferred embodiment of the present invention.

FIG. 3 is a flow chart of a method for displaying an expressional image according to a preferred embodiment of the present invention.

FIG. 4 is a schematic view of the facial image according to another preferred embodiment of the present invention.

FIG. 5 is a schematic view of a facial image variation in accordance with an action episode according to a preferred embodiment of the present invention.

FIG. 6 is a flow chart of a method for displaying an expressional image according to another preferred embodiment of the present invention.

FIG. 7 is a schematic view of switching an expressional type of a facial image according to a preferred embodiment of the present invention.

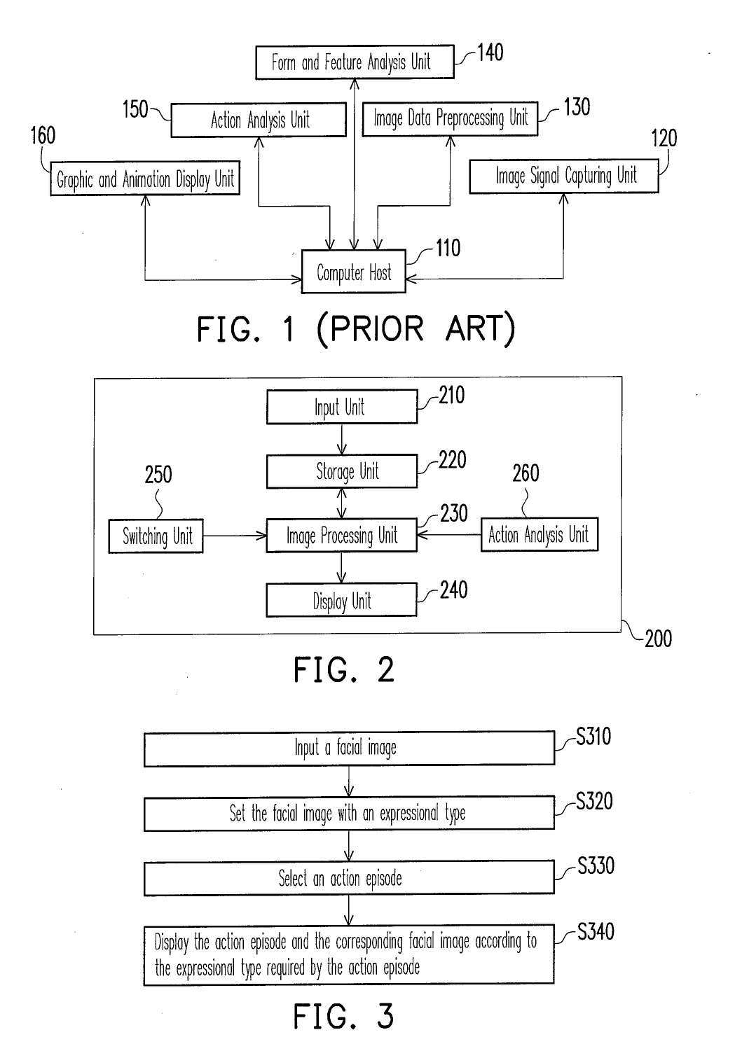

### DESCRIPTION OF EMBODIMENTS

In order to make the content of the present invention more comprehensible, embodiments are made hereinafter as examples for implementing the present invention.

FIG. 2 is a block diagram of an expressional image display device according to a preferred embodiment of the present invention. Referring to FIG. 2, the expressional image display device 200 of the embodiment can be, but not limited to, any electronic device 240 having a display unit, such as a personal computer, a notebook computer, a mobile phone, a personal digital assistant (PDA), or a potable electronic device of another type. The image display device 200 further includes an input unit 210, a storage unit 220, an image processing unit 230, a display unit 240, and a switching unit 250.

The input unit 210 is used to capture or receive images input by a user. The storage unit 220 is used to store the images input by the input unit 210 and the images that have been processed by the image processing unit 230, and the storage unit 220 can be a buffer memory and the like, and this embodiment is not limited herein. The image processing unit 230 is used to set the input images with the expressional types, and the display unit 240 is used to display an action episode and a facial image matching the action episode. In addition, the switching unit 250 is used to switch the expressional type so as to make the facial image match the action episode, and the action analysis unit 260 detects and analyzes the actions of the user, and automatically selects the action episode.

For example, as for displaying an expressional image on a personal computer, the user can input the image captured by a digital camera to the personal computer through a transmission cable, and set the previously input facial image with an expressional type. Then, the user selects one action episode, and meanwhile the personal computer displays a corresponding expressional type according to the requirement of the action episode, and finally displays the action episode and the corresponding expressional type on the computer screen.

FIG. 3 is a flow chart of the method for displaying an expressional image according to a preferred embodiment of the present invention. Referring to FIG. 3, in this embodiment, the input facial image is set with an expressional type in advance, and thus when using the expressional image displaying function subsequently, the expressional image corresponding to the action episode will be automatically displayed only by selecting the action episode. The details of the steps of the method for displaying an expressional image according to the present invention are further illustrated together with the expressional image display device described in the above embodiment as follows.

Referring to FIG. 2 and FIG. 3 together, first, the user makes use of the input unit 210 to select and input a facial image (step S310), the facial image is, for example, an image acquired by shooting the face of the user with a camera, an image read from a hard disc of a computer, or an image downloaded from the network, depending on the requirement of the user. The facial image after being input is stored in the storage unit 220 for being accessed and used by the expressional image display device 200 as required. Next, the user set the facial image with an expressional type by using the input unit 210 according to the actions of the face of the facial image (step S320). The expressional type includes, but is not limited to, peace, pain, excitement, anger, fatigue, or the like. For example, if the corners of mouth of the facial image rise, the facial image can be set with the expressional type of smile.

It should be noted that the preferred embodiment of the present invention further includes repeating the above steps S310 and S320 to input a plurality of facial images and setting the facial images with the expressional types. In other words, after inputting a facial image and setting a corresponding expressional type, another facial image is input and set with the expressional type, and so forth. Otherwise, a plurality of facial images is input at a time, and then is set with the expressional types respectively, and the present invention is not limited herein.

After the input of the facial images and the set of the expressional types are completed, an action episode is then selected (step S330). The action episode is similar to the shot scene selected by the user before shooting sticker photos, in which the shot scene includes action poses, dresses, bodies, limbs, hairs, facial features etc. of the character, except that the action episode of the present invention is dynamic video frames capable of representing actions made by the user. The action episode can be selected by the user with the input unit 210, or can be selected automatically by detecting and analyzing the actions of the user with an action analysis unit 260. However, the present invention is not limited herein.

Finally, according to the expressional type required by the action episode, the image processing unit 230 displays the action episode and the corresponding facial image on the display unit 240 (step S340). The step can be further divided into sub-steps including selecting a corresponding facial image according to the expressional type required by the action episode, inserting the facial image in the position where the face is placed in the action episode, and finally displaying the action episode including the facial image. For example, if the expressional type required by the action episode is delight, the facial image with the expressional type of delight can be selected, the facial image is inserted in the facial portion in the action episode, and finally the action episode including the facial image is displayed.

In the preferred embodiment of the present invention, the step of displaying the facial image further includes rotating and scaling the facial image with the image processing unit 230, so as to make the facial image match the direction and size of the face in the action episode. As the sizes and directions of facial images corresponding to various action episodes are different, the facial image must be rotated and scaled properly according to the requirement of the action episode, such that the proportion of the character is proper.

This embodiment further dynamically plays a plurality of actions of the action episode, for example, continuously plays the action of raising the right foot and the action of raising the left foot so as to form a dynamic action of strolling. In addition, in this embodiment, whether or not to display the background image is selected according to the expressional type required by the action episode, for example, if the action episode is an outdoor action episode, a background of blue sky and white cloud can be displayed depending on the requirement of the user.

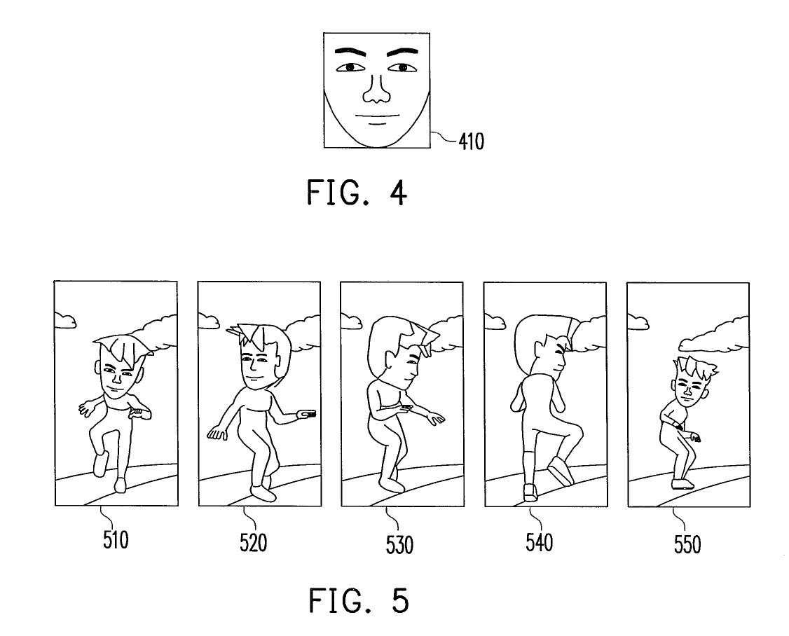

According to the description of the above embodiment, another embodiment is further illustrated in detail. FIG. 4 is a schematic view of the facial image according to another preferred embodiment of the present invention. Referring to FIG. 4, the user inputs a facial image to be used first, and options for setting the expressional types are shown Up for the user to set, in which it is assumed that the user set the expression of the facial image 410 is peace.

FIG. 5 is a schematic view of a facial image variation in accordance with an action episode according to a preferred embodiment of the present invention. Referring to FIG. 5, after setting the expressional type, an action episode is selected, in which the setting includes action poses, dresses, bodies, limbs, hairs, facial features etc. of the character. It is assumed that the action episode selected by the user is furtive, the setting of this action episode includes a dress of Bruce Lee's dressing style, short hair with fringes, a common male body, naked palms, feet with shoes, and ears added to the facial image.

After setting the action episode, the facial image corresponding to the expressional type is selected according to the setting. In this embodiment, it is suitable for the furtive action episode to match with the facial image 410 of the expressional type of peace. In order to meet the requirement of the action episode, the facial image 410 is rotated and scaled. The facial image in an expressional image 550 has been scaled down obviously to match the proportion of the character in the action episode, and the direction of the facial images in the expressional images 510-550 has been adjusted to match the action episode, i.e., the facial images are rotated to face the direction set by the action episode.

It should be noted that in this embodiment the originally input facial images are common 2D images. In this embodiment, a 3D simulation is adopted to generate facial images of different directions. As shown in FIG. 4 and FIG. 5, the facial images not only include the originally input front image (e.g., the facial image 410), but also include the simulated images of various directions, such as left face (e.g., an expressional image 520), right face (e.g., an expressional image 530), head turning (e.g., an expressional image 540), and head down (e.g., the expressional image 510). The expressional images 510-550 are dynamically played in accordance with the setting of the action episode, thereby simulating a complete action.

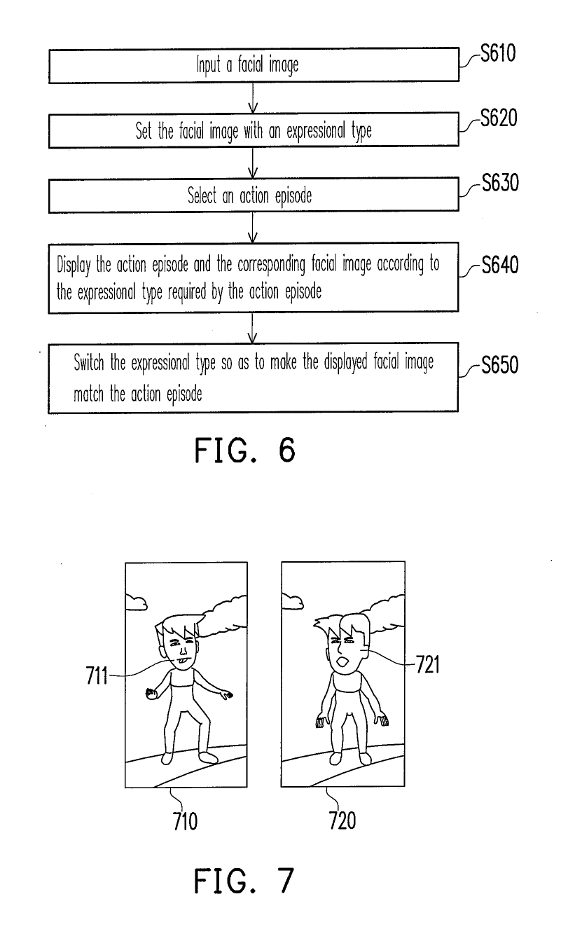

FIG. 6 is a flow chart of the method for displaying an expressional image according to another preferred embodiment of the present invention. Referring to FIG. 6, in this embodiment, in addition to displaying corresponding expressional image according to the action episode selected by the user, the user can further switch the facial images freely, so as to make the displayed facial image match the action episode. The details of the steps of the method for displaying an expressional image according to the present invention are further illustrated together with the expressional image display device described in the above embodiment.

Referring to FIGS. 2 and 6 together, first, the user selects to input a facial image by using the input unit 210 (step S610), and then sets an expressional type of the facial image by using the input unit 210 (step S620). The facial image after being input is stored in the storage unit 220 for being accessed and used by the expressional image display device 200 later as required. Definitely, as described above, the user can input a plurality of images repeatedly and set the expressional types individually, so as to provide more selection for the subsequent application of the present invention.

After the input of the facial images and the set of the expressional types are completed, an action episode can be selected by the user with the input unit 210, or can be selected automatically by detecting and analyzing the action of the user with an action analysis unit 260 (step S630), and the computer displays the action episode and the corresponding facial image on the display unit 240 according to the expressional type required by the action episode (step S640). The detailed content of the above steps are all identical or similar to the steps S310-S340 in the above embodiment, and will not be described herein again.

However, the difference therebetween lies in that the embodiment further includes manually switching the displayed expression by the user with a switching unit 250 (step S650), so as to make the displayed facial image match the action episode. In other words, if the user is not satisfied with the automatically displayed expressional type, he/she can switch the expressional type manually without resetting the facial image, which is quite convenient.

For example, FIG. 7 is a schematic view of switching the expressional type of the facial image according to a preferred embodiment of the present invention. Referring to FIG. 7, in an expressional image 710, a facial image 711 of sticking out the tongue belongs to the expressional type of “naughty”, and it seems awkward if it is inserted in the action episode of “walking in the sunshine”, at this point, the user can switch the expressional type to “fatigue” to meet the requirement. At this time, an expressional image 720 is displayed, as shown in the figure, the expressional image 720 with an opened mouth in a facial image 721 matches the action episode properly. It can be known from the above description that the user can obtain the most proper expressional image only by switching the expressional type of the displayed facial image according to the method of the present invention.

In view of the above, the method for displaying an expressional image according to the present invention at least includes the following advantages.

1. The user can select and input the images of any character by the use of various image inputting devices, thereby enhancing the flexibility in selecting image.

2. 3D images of different directions can be simulated by only inputting a plurality of two-dimensional facial images, and the expression of the character can be livingly exhibited in accordance with the selected action episode.

3. The expressional mage is displayed by dynamic playing, and different facial images can be switched as required, thereby enhancing the recreation effect in use.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for displaying an expressional image, comprising:
inputting a facial image;
setting the facial image with an expressional type;
selecting an action episode; and
displaying the action episode and the corresponding facial image according to the expressional type required by the action episode.

2. The method for displaying an expressional image as claimed in claim 1, wherein after setting the facial image with the expressional type, the method further comprises:
inputting a plurality of facial images, and setting each of the facial images with the expressional type.

3. The method for displaying an expressional image as claimed in claim 1, wherein each time after inputting the facial image, the method further comprises:
storing the facial image.

4. The method for displaying an expressional image as claimed in claim 1, wherein the step of displaying the action episode and the corresponding facial image according to the expressional type required by the action episode comprises:
selecting the corresponding facial image according to the expressional type required by the action episode;
inserting the facial image in a position where the face is placed in the action episode; and
displaying the action episode containing the facial image.

5. The method for displaying an expressional image as claimed in claim 4, the step of displaying the action episode and the corresponding facial image according to the expressional type required by the action episode further comprises:
rotating and scaling the facial image, so as to make the facial image match the direction and size of the face in the action episode.

6. The method for displaying an expressional image as claimed in claim 5, further comprising:
dynamically playing a plurality of actions of the action episode; and
adjusting the direction and size of the facial image according to the currently played action.

7. The method for displaying an expressional image as claimed in claim 1, further comprising:
displaying a background image according to the expressional type required by the action episode.

8. The method for displaying an expressional image as claimed in claim 7, further comprising:
switching the expressional type, so as to make the displayed facial image match the action episode.

9. The method for displaying an expressional image as claimed in claim 1, wherein each of the action episodes comprises one of action poses, dresses, bodies, limbs, hairs, and facial features of a character or a combination thereof.

10. The method for displaying an expressional image as claimed in claim 1, wherein the expressional type comprises one of peace, pain, excitement, anger, and fatigue.
